(19) United States
(12) Patent Application Publication
(10) Pub. No.: US 2013/0224028 A1
(43) Pub. Date: Aug. 29, 2013

(54) COMPONENT BLENDING TOOL ASSEMBLY

(71) Applicants: Nathan D. Korn, Glastonbury, CT (US); Charles P. Gendrich, Middletown, CT (US); Jonathan E. Daggett, Portland, CT (US); Robert E. Shepler, South Windsor, CT (US); David P. Houston, Glastonbury, CT (US); David M. Nissley, Marlborough, CT (US); Stephen D. Hoyt, Glastonbury, CT (US); Ron I. Prihar, West Hartford, CT (US)

(72) Inventors: Nathan D. Korn, Glastonbury, CT (US); Charles P. Gendrich, Middletown, CT (US); Jonathan E. Daggett, Portland, CT (US); Robert E. Shepler, South Windsor, CT (US); David P. Houston, Glastonbury, CT (US); David M. Nissley, Marlborough, CT (US); Stephen D. Hoyt, Glastonbury, CT (US); Ron I. Prihar, West Hartford, CT (US)

(21) Appl. No.: 13/407,209

(22) Filed: Feb. 28, 2012

(51) Int. Cl. F01D 5/02; B24B 19/14; B23P 15/00; B24B 1/00

(52) U.S. Cl. 416/204 A; 451/540; 451/28; 29/889.23

(57) ABSTRACT

A component blending tool assembly, includes a material removing surface that is moved to provide a blended area in a component, the material removing surface having a spherical contour mimicking a predetermined depth ratio of the blended area.

### BACKGROUND

This disclosure relates generally to a component blending tool and, more particularly, to a component blending tool having a contoured material removing surface that facilitates creating a blend area having a desired width to depth ratio.

Turbomachines, such as gas turbine engines, typically include a fan section, a turbine section, a compressor section, and a combustor section. Turbomachines may employ a geared architecture connecting the fan section and the turbine section.

Components of assemblies may include imperfections, such as nicks, dents, scratches, etc. In high-performance assemblies, such as the above-mentioned turbomachines, imperfections can reduce strength or fatigue life, especially in components that rotate during operation. Component stresses are increased adjacent to imperfections. The increased stress originating at an unrepaired imperfection can become an initiation site for a crack that can propagate until structural failure. Relatively small imperfections, such as imperfections less than 0.010 inches (0.254 mm) deep, are often blended from components to repair, rather than scrap, the component. Removing the imperfection helps prevent structural failure of the components. As appreciated, scrapping components is costly.

Blending away an imperfection involves removing material from an area of the component to eliminate the imperfection. The area of removed material has a width and a depth. A depth ratio is a ratio of the width to the depth. High-performance assemblies may require relatively high depth ratios greater than 100 to 1 to minimize the abruptness of surface changes due to the blending. Relatively high depth ratios are difficult to achieve and expensive to verify.

### SUMMARY

A component blending tool according to an exemplary aspect of the present disclosure includes, among other things, a material removing surface that is moved to provide a blended area in a component, the material removing surface having a spherical contour mimicking a predetermined depth ratio of the blended area.

In a further non-limiting embodiment of the foregoing component blending tool, the entire material removing surface has the spherical contour.

In a further non-limiting embodiment of either of the foregoing component blending tools, the material removing surface is annular and coaxial with a rotational axis of the material removing surface.

In a further non-limiting embodiment of either of the foregoing component blending tools, the annular material removing surface provides an opening that does not include any material removing surface.

In a further non-limiting embodiment of any of the foregoing component blending tools, a diameter of the material removing surface is greater than a diameter of the blended area.

In a further non-limiting embodiment of any of the foregoing component blending tools, the predetermined depth ratio is a ratio of a diameter of the blended area to a depth of the blended area.

In a further non-limiting embodiment of any of the foregoing component blending tools, the depth of the blended area is about 0.002 inches (0.0508 millimeters) greater than a depth of an imperfection in the component that is removed when providing the blended area.

In a further non-limiting embodiment of any of the foregoing component blending tools, the predetermined depth ratio is greater than 15 to 1.

In a further non-limiting embodiment of any of the foregoing component blending tools, the predetermined depth ratio is greater than about 100 to 1.

In a further non-limiting embodiment of any of the foregoing component blending tools, the component is a turbomachine component.

A component having a blended area according to an exemplary embodiment of the present disclosure includes a component surface of the component. The component surface has a blended area that has a depth ratio. The blended area is cut into the component by a cutting surface of a material removing tool. The cutting surface has a contour mimicking a desired depth ratio of the blended area.

In a further non-limiting embodiment of the foregoing component having a blended area, the component is a rotor of a turbomachine.

In a further non-limiting embodiment of either of the foregoing components having a blended area, the depth ratio is greater than 15 to 1.

In a further non-limiting embodiment of any of the foregoing components having a blended area, the depth ratio is about 200 to 1.

In a further non-limiting embodiment of any of the foregoing components having a blended area, the predetermined depth ratio is a ratio of a diameter of the blended area to a depth of the blended area.

In a further non-limiting embodiment of any of the foregoing components having a blended area, the depth of the blended area is about 0.002 inches (0.0508 millimeters) greater than a depth of an imperfection in the component that is removed when providing the blended area.

In a further non-limiting embodiment of any of the foregoing components having a blended area, the cutting surface is rotated about an axis extending from the component surface.

A method of removing an imperfection from a component according to another exemplary aspect of the present disclosure includes, among other things, moving a material removing surface having a spherical material removing surface contour against a component surface to remove material from the component surface. The material removing surface contour has a depth ratio that is the same as a desired depth ratio for a blend area created by the material removing surface.

In a further non-limiting embodiment of the foregoing method, the depth ratio of the material removing surface contour and the desired depth ratio are both about 200 to 1.

In a further non-limiting embodiment of either of the foregoing methods, the component surface is a surface of a turbomachine component.

In a further non-limiting embodiment of any of the foregoing methods, the material removing surface is rotating about an axis. The method further includes pivoting about a pivot point during the rotating.

### DESCRIPTION OF THE FIGURES

The various features and advantages of the disclosed examples will become apparent to those skilled in the art from the detailed description. The figures that accompany the detailed description can be briefly described as follows:

FIG. 1 shows a highly schematic view of an example turbomachine.

FIG. 2 shows an example rotor of the FIG. 1 turbomachine.

FIG. 3 shows a close-up view of the blended area of the FIG. 2 rotor.

FIG. 4a shows a section view of an imperfection in the FIG. 2 rotor removed by the blended area.

FIG. 4b shows a section view of the FIG. 3 blended area.

FIG. 5 shows a perspective view of an example component blending tool used to establish the FIG. 3 blended area.

FIG. 6 shows a side view of the FIG. 5 component blending tool.

FIG. 7 shows an end view of the FIG. 5 component blending tool.

FIG. 8 shows a close up view of a portion of a material removing surface of the FIG. 5 component blending tool having an exaggerated contour.

### DETAILED DESCRIPTION

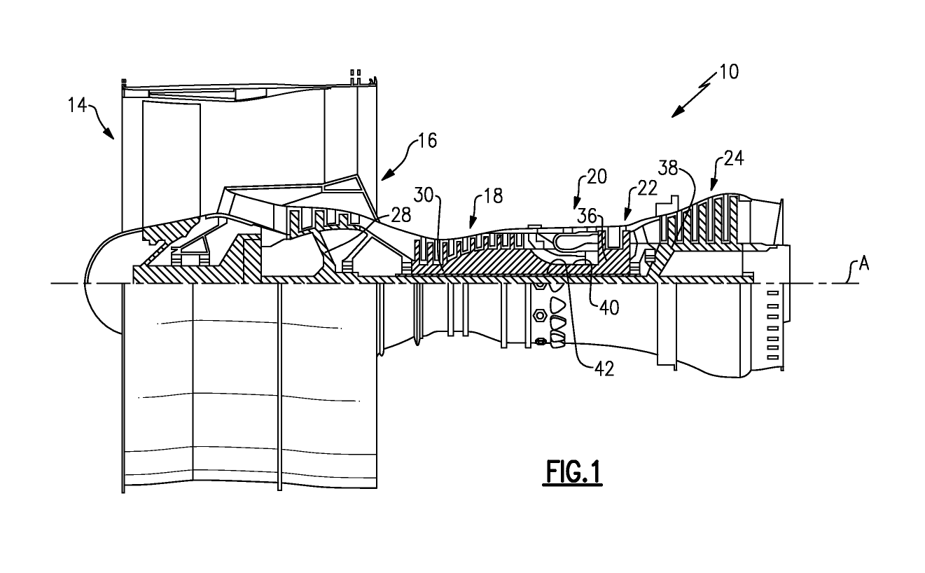

Referring to FIG. 1, an example turbomachine, such as a gas turbine engine 10, is circumferentially disposed about an axis A. The gas turbine engine 10 includes a fan section 14, a low-pressure compressor section 16, a high-pressure compressor section 18, a combustion section 20, a high-pressure turbine section 22, and a low-pressure turbine section 24. Other example turbomachines may include more or fewer sections.

During operation, air is compressed in the low-pressure compressor section 16 and the high-pressure compressor section 18. The compressed air is then mixed with fuel and burned in the combustion section 20. The products of combustion are expanded across the high-pressure turbine section 22 and the low-pressure turbine section 24.

The low-pressure compressor section 16 and the high-pressure compressor section 18 each include rotors 28 and 30, respectively. The example rotors 28 and 30 include alternating rows of rotatable blades and static stators or vanes.

The high-pressure turbine section 22 and the low-pressure turbine section 24 each include rotors 36 and 38, respectively. The example rotors 36 and 38 include alternating rows of rotatable blades and static stators or vanes.

The rotors 36 and 38 rotate in response to the expansion to rotatably drive rotors 28 and 30. The rotor 36 is coupled to the rotor 30 with a spool 40, and the rotor 38 is coupled to the rotor 28 with a spool 42.

The examples described in this disclosure are not limited to the described gas turbine engine 10 and may be used in association with components other than gas turbine engine components, and other than turbomachine components. The examples described in this disclosure are also not limited to the two-spool gas turbine architecture described, and may be used in other architectures, such as a single-spool axial design, a three-spool axial design, and still other architectures. That is, there are components from various types of assemblies, such as gas turbine engines and other turbomachines, that can benefit from the examples disclosed herein.

Referring to FIGS. 2 to 4b, the rotor 36 includes a blended area 50 created when removing an imperfection 52, such as a nick, crack, scratch, etc. In this example, the blended area 50 has a 200 to 1 depth ratio. That is, the diameter D of the blended area 50 is 200 times greater than the depth d of the blended area 50. The blended area 50 is established on an original outer surface 56 of the rotor 36. In another example, a diameter of the blended area 50 is 100 times greater than the depth of the blended area. The depth ratio is considered a “blend ratio” in some examples.

The example blended area 50 is shown as having a circular profile. As appreciated, the profile of the blended area 50 may be oval-shaped or some other shape depending on the contours of the original outer surface 56 and an outer surface 54 surrounding the blended area 50. The depth ratio of the blended area 50 is generally represented by the smallest diameter D of the blended area 50. That is, portions of an oval-shaped blended area may be greater than 200 to 1, but such the blended area is still considered to have a depth ratio of 200 to 1. A desired depth ratio for the blended area 50 is often considered to be a minimum depth ratio for the blended area 50.

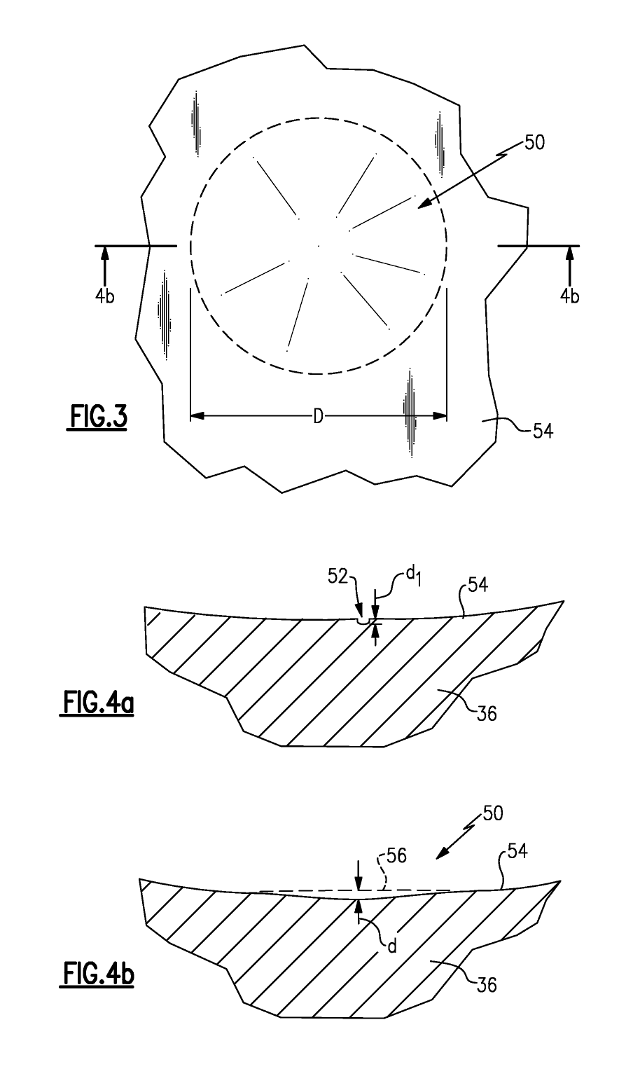

The depth d of the blended area 50 relative to an original outer surface 56 is determined based on the depth of the imperfection 52 removed by the blended area 50. In some examples, the depth d of the blended area 50 is less than about 0.005 inches (0.127 millimeters) deeper than the imperfection depth d₁ (FIG. 4a), which represents the greatest depth of the imperfection 52. In one specific example, the depth d of the blended area 50 is about 0.002 inches (0.0508 millimeters) deeper than the imperfection depth d₁ (FIG. 4a).

In one example, the desired depth ratio of the blended area 50 is based on the component. In this example, repair instructions for repairing the rotor 36 require that the blended area 50 has a depth ratio that is about 200 to 1. Such depth ratios are more difficult to achieve and verify than a lower depth ratio, such as a 15 to 1 depth ratio, which is typically required in less highly stressed components.

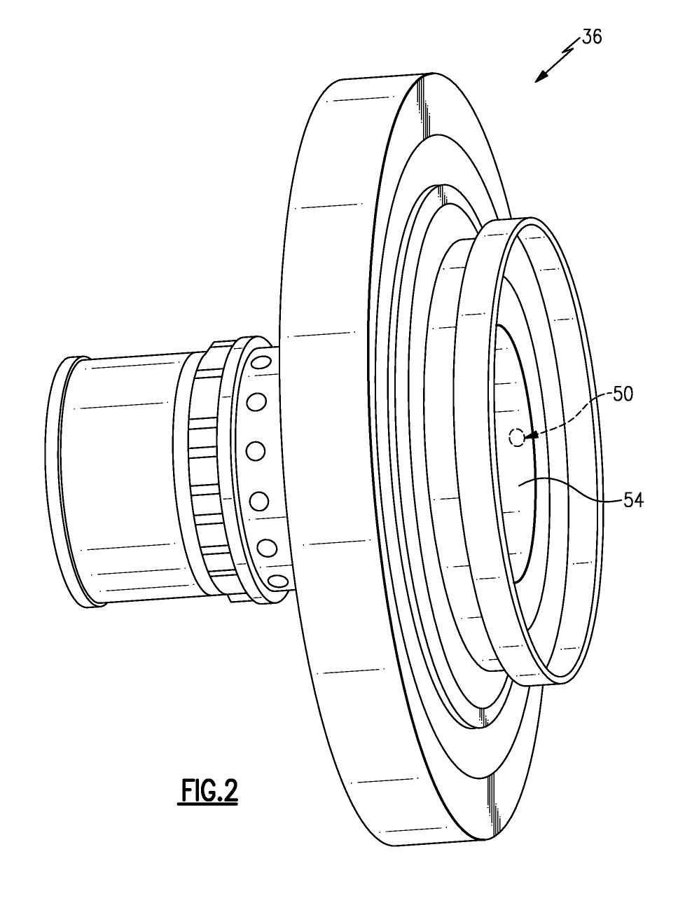

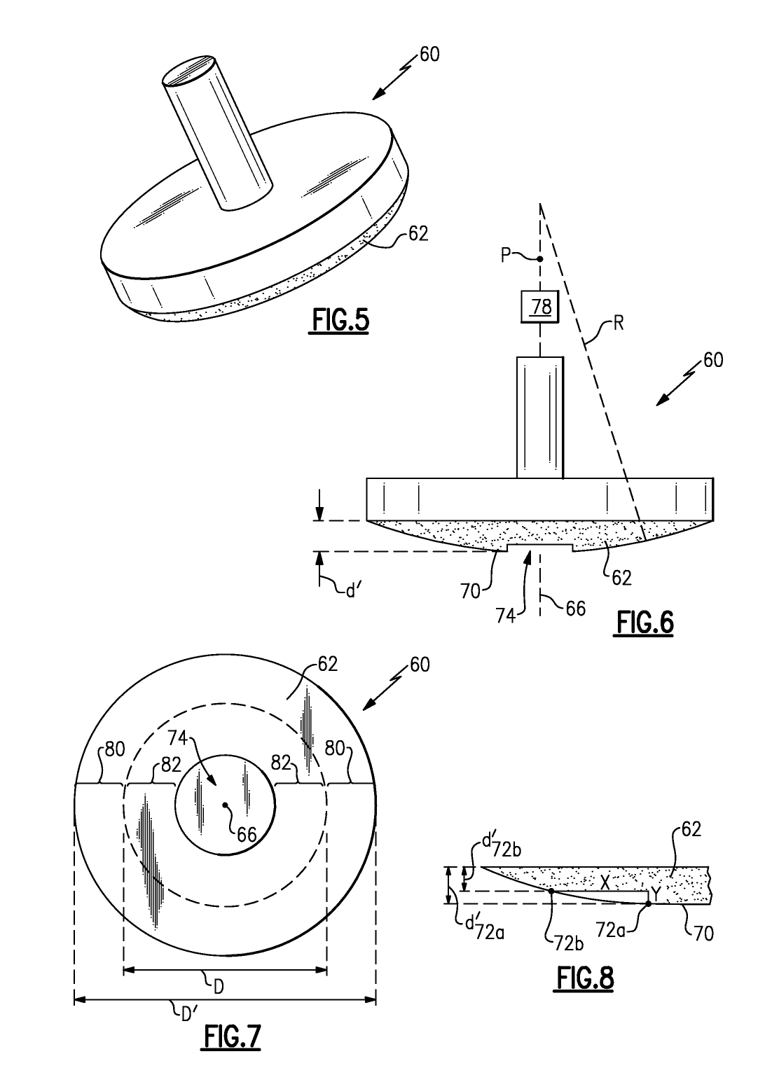

Referring to FIGS. 5 to 8 with continuing reference to FIGS. 3 to 4b, a component blending tool assembly 60 includes a material removing surface 62 that is rotated about an axis 66 to establish the blended area 50. The material removing surface 62 is the portion of the blending tool 60 that removes material from the component, which in this example is the rotor 36.

As perhaps best shown in FIG. 6, the material removing surface 62 has a material removing surface contour 70 that is spherical. Notably, the material removing surface contour 70 is the same as the desired contour of the blended area 50. That is, a ratio of a diameter D′ of the material removing surface 62 to a depth d′ of the material removing surface 62 is 200 to 1. The material removing surface contour 70 thus mimics a desired contour of the blended area 50. The depth d′ represents an axial distance the material removing surface contour 70 extends from the component blending tool 60. The desired contour of the blended area has a depth ratio that is predetermined. The predetermined depth ratio is a ratio of a diameter of the blended area to a depth of the blended area.

In this example, the material removing surface contour 70 corresponds to a sphere having a radius R of 5,000.5 millimeters if the diameter D of the blended area 50 is desired to be 200 millimeters and the depth ratio is 200 to 1. In other examples, the material removing surface contour 70 corresponds to a radius that is greater or less than the radius R.

In this example, the blending tool 60 is selected based on the required depth ratio of the blend area 50. Because the repair instructions in this example require a 200 to 1 depth ratio in the blend area 50, the tool selected by the repair technician should have a material removing surface having a depth ratio of 200 to 1. The repair technician may select the blending tool 60 from several tools having different material removing surface contours.

The depth ratio is the same across the entire example material removing surface 62. For example, a first location 72a on the material removing surface 62 has a greater depth d′₇₂ₐ than a depth d′_{72b} at a second location 72b. Provided the first location 72a is circumferentially aligned along radius R with the second location 72b, a depth ratio of a first location to a second axial location is always 200 to 1. That is, the radial distance X between the first location 72a and the second location 72b is 100 times greater than the axial distance Y in this example. Notably, the contour 70 in the Figures is exaggerated for clarity.

In this example, the material removing surface 62 is an abrasive surface suitable for removing material from the rotor 36. In another example, the material removing surface 62 is a cutting, rather than an abrasive, surface. A person having skill in this art and the benefit of this disclosure would understand how to make suitable abrasive material or cutting features for the material removing surface 62. For example, a suitable abrasive may be dictated by the material of the object to be blended. Cutting fluids, or the absence thereof, would be determined by the specific abrasive or cutting material and the material of the object to be blended.

The example material removing surface 62 is annular and arranged about the rotational axis 66 the material removing surface 62. The material removing surface 62 being annular establishes a recessed area or opening 74 near the rotational axis 66 of the component blending tool. During operation, rotational speeds radially near the axis 66 are not fast enough to effectively remove material from areas of the outer surface 54 near the axis 66. This area of the example component blending tool 60 is thus open and does not include a material removing surface 62.

In another example, the component blending tool 60 does not include the opening 74. The material removing surface 62 of such a blending tool is continuous, uninterrupted, and is not annular. Such a tool would be used with a pivoting motion, detailed below when blending relatively long scratch-type imperfections.

When creating the blended area 50, the repair technician presses the component blending tool 60 against the portions of the outer surface 54 containing the imperfection 52. The component blending tool 60 is then rotated about the axis 66. Other examples may oscillate, rather than rotate, the blending tool 60. A hand tool 78, such as a drill, may be used to rotate the component blending tool 60 about the axis 66. In another example, the blending tool 60 movement is robotically controlled.

Rotating the material removing surface 62 of the component blending tool 60 against the outer surface 54 removes material. Cooling fluid may be used to remove thermal energy during the rotating. As appreciated, material is not removed from the portions of the outer surface 54 aligned with the opening 74. To remove material from these portions of the outer surface 54, the repair technician pivots the component blending tool 60 about a pivot point P while maintaining contact of surface 62 with the previously ground surface 50. The pivoting movement causes the material removing surface 62 to contact these portions of the outer surface 54. The pivoting may be controlled or accomplished by hand.

In this example, the diameter D′ of the component blending tool 60 is oversized relative to the blended area 50. As the component blending tool 60 pivots about the point P, the areas 80 of the material removing surface 62 contact the outer surface 54 and remove material. Also, other areas 82 of the material removing surface 62 come into contact with the portion of the outer surface 54 that were aligned with the opening 74 prior to the pivoting. The other areas 82 remove material from this portion of the outer surface 54.

The repair technician removes the component blending tool 60 from the blended area 50 after the pivoting. Because the material removing surface 62 of the component blending tool 60 has the material removing surface contour 70 that mimics a desired depth ratio of the blended area 50, the blended area 50 has the desired depth ratio.

Features of the disclosed examples include creating a blended area within a component to remove an imperfection in the component while providing a desired depth ratio to the blend area. Complicated measurement techniques and depth ratio verification methods are not required as the tool is configured to establish an appropriate depth ratio.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A component blending tool assembly, comprising:
a material removing surface that is moved to provide a blended area in a component, the material removing surface having a spherical contour mimicking a predetermined depth ratio of the blended area.

2. The component blending tool assembly of claim 1, wherein the entire material removing surface has the spherical contour.

3. The component blending tool assembly of claim 1, wherein the material removing surface is annular and coaxial with a rotational axis of the material removing surface.

4. The component blending tool assembly of claim 3, wherein the annular material removing surface provides an opening that does not include any material removing surface.

5. The component blending tool assembly of claim 1, wherein a diameter of the material removing surface is greater than a diameter of the blended area.

6. The component blending tool assembly of claim 1, wherein the predetermined depth ratio is a ratio of a diameter of the blended area to a depth of the blended area.

7. The component blending tool assembly of claim 6, wherein the depth of the blended area is less than about 0.005 inches (0.127 millimeters) greater than a depth of an imperfection in the component that is removed when providing the blended area.

8. The component blending tool assembly of claim 1, wherein the predetermined depth ratio is greater than 15 to 1.

9. The component blending tool assembly of claim 1, wherein the predetermined depth ratio is about greater than about 100 to 1.

10. The component blending tool assembly of claim 1, wherein the component is a turbomachine component.

11. A component having a blended area, comprising:
a component surface of the component, the component surface having a blended area that has a depth ratio, the blended area cut into the component by a cutting surface of a material removing tool, the cutting surface having a contour mimicking a desired depth ratio of the blended area.

12. The component of claim 11, wherein the component is a rotor of a turbomachine.

13. The component of claim 11, wherein the depth ratio is greater than 15 to 1.

14. The component of claim 11, wherein the depth ratio is about 200 to 1.

15. The component of claim 11, wherein the predetermined depth ratio is a ratio of a diameter of the blended area to a depth of the blended area.

16. The component of claim 11, wherein the depth of the blended area is less than about 0.005 inches (0.127 millimeters) greater than a depth of an imperfection in the component that is removed when providing the blended area.

17. The component of claim 11, wherein the cutting surface is rotated about an axis extending from the component surface.

18. A method of removing an imperfection from a component, comprising:
moving a material removing surface having a spherical material removing surface contour against a component surface to remove material from the component surface, wherein the material removing surface contour has a depth ratio that is the same as a desired depth ratio for a blend area created by the material removing surface.

19. The method of claim 18, wherein the depth ratio of the material removing surface contour and the desired depth ratio are both about 200 to 1.

20. The method of claim 18, wherein the component surface is a surface of a turbomachine component.

21. The method of claim 18, wherein the moving is rotating about an axis, and further including pivoting about a pivot point during the rotating.
